(19) United States
(12) Patent Application Publication
(10) Pub. No.: US 2011/0244892 A1
(43) Pub. Date: Oct. 6, 2011

(54) PICO BASE STATION LOCATION AND ANALYSIS USING MOBILE DEVICES

(75) Inventors: Gerard MacManus, Foothill Ranch, CA (US); Khurram P. Sheikh, San Clemente, CA (US)

(73) Assignee: POWERWAVE TECHNOLOGIES, INC., Santa Ana, CA (US)

(21) Appl. No.: 13/078,585

(22) Filed: Apr. 1, 2011

Related U.S. Application Data
(60) Provisional application No. 61/321,085, filed on Apr. 5, 2010.

(51) Int. Cl. H04W 64/00

(52) U.S. Cl. 455/457

(57) ABSTRACT

A base station analysis system and method that may employ commercially-available mobile device platforms is disclosed. The base station analysis application enables a service technician to locate nearby base stations in the field, determine which base stations are functioning properly, and retrieve information associated with the base stations. The mobile device displays nearby base stations on a street map relative to the location of the mobile device in an embodiment. The mobile device preferably displays the spatially-varying signal strength for the active base stations to enable the service technician to locate dead spots in the coverage. The mobile device displays a reality augmented view having graphical icons which represent base stations embedded within a street-view image obtained by the mobile device camera in a preferred embodiment. When a service technician selects a base station icon, installation information describing the base station is provided.

### RELATED APPLICATION INFORMATION

The present application claims priority under 35 U.S.C. Section 119(e) to U.S. Provisional Patent Application Ser. No. 61/321,085 filed Apr. 5, 2010, the disclosure of which is incorporated herein by reference in its entirety.

### BACKGROUND OF THE INVENTION

1. Field of the Invention

The present invention relates generally to wireless communication systems and methods. More particularly, the invention relates to systems and methods for locating and analyzing the performance of wireless base stations.

2. Description of the Prior Art and Related Background Information

Modern telecommunication systems employ multiple base stations for communicating with consumers' mobile devices over a wide geographic area. While there are currently several tools available to field service technicians to locate malfunctioning base stations, these tools are typically single-function devices that may lack the versatility to adapt to ever-changing technologies.

Accordingly, a need exists to provide tools for service technicians in the field.

### SUMMARY OF THE INVENTION

In the first aspect, the present invention provides a method for detecting and displaying information describing nearby base stations. The method comprises determining a location of a mobile device, determining locations of nearby base stations located near the mobile device, generating a map graphic having a plurality of icons representing the location of the mobile device and the locations of the nearby base stations and, displaying the map graphic.

In a preferred embodiment, the mobile device comprises a GPS radio (Global Positioning System) and determining the location of the mobile device preferably comprises employing the GPS radio for determining the location of the mobile device.

The mobile device preferably further comprises a base station database and determining the location of nearby base stations preferably further comprises determining the location of nearby base stations based on the base station database. The method preferably further comprises determining which of the nearby base stations are active base stations and which are non-active base stations, and wherein the plurality of icons representing the locations of the nearby base stations further comprise a plurality of icons representing the locations of the active base stations and the locations of the non-active base stations. Determining which of the nearby base stations are active base stations and which of the nearby base stations are non-active base stations preferably comprises transmitting a message from the mobile device, receiving the message at the nearby base stations, transmitting a response base identification message from the nearby base stations to the mobile device, receiving the response base identification message, and, classifying the nearby base stations as active base stations or non-active base stations based on the transmitted response base identification message.

The method preferably further comprises determining the coverage areas for each of the active base stations, and displaying the coverage areas on the map graphic. The coverage areas preferably further comprise indicators of the spatially-varying signal strength of each of the active base stations. The spatially-varying signal strength of each of the active base stations is preferably based on the measured signal strength of signals transmitted by the active base stations. The spatially-varying signal strength of each of the active base stations may also be based on theoretical estimates of the signal strength. The method preferably further comprises recording signal strength information collected as the mobile device is moved. The method may further comprise contacting a network planning office and transmitting instructions to increase or decrease the power level for one or more of the active base stations.

In another aspect, the present invention provides a method for detecting and displaying information describing nearby base stations. The method comprises determining a position of a mobile device having a camera, determining a location of a nearby base station located near the mobile device, obtaining an image from the camera, generating an icon representing the location of the nearby base station, generating an augmented reality image based on the image and the icon, and displaying the augmented reality image.

In a preferred embodiment, the method further comprises determining a location of a second nearby base station located near the mobile device, generating an icon identifying the second nearby base station, and displaying the icon identifying the nearby base station. The method preferably further comprises generating a summary display listing the nearby base stations and the relative locations of the nearby base stations relative to the position of the camera. The mobile device preferably further comprises a GPS (Global Positioning System) and determining the position of the mobile device comprises employing the GPS for determining the position of the mobile device. The method may further comprise contacting a network planning office and transmitting instructions to increase or decrease the power level for one or more of the active base stations.

In another aspect, the present invention provides a method for detecting and displaying information describing nearby base stations. The method comprises displaying a map indicating nearby base stations on a mobile device, receiving a request for information describing a base station displayed on the mobile device by a user of the mobile device, retrieving the information describing the base station, and displaying the information describing the base station on the mobile device.

In a preferred embodiment, the mobile device further comprises a base station database, such that retrieving the information describing the base station further comprises retrieving the information describing the base station from the base station database. The information describing the base station preferably includes one or more of the downlink frequency band, the number of channels, the bandwidth of the base station, the minimum and maximum downlink output power levels, the gains adjustment range, the noise figure, the power supply, the power consumption, the RD connector type, the base station name, the owner of the base station, the model of the base station, the installation date of the base station, and the type of antenna employed by the base station. The method may further comprise providing active Internet website links for websites associated with the base station.

Further features and aspects of the invention are set out in the following detailed description.

### BRIEF DESCRIPTION OF THE DRAWINGS

FIG. 1A is a top view of a mobile device displaying an activity mapping having a street map with icons associated with nearby base stations in accordance with an embodiment of the present invention.

FIG. 1B is a flow chart illustrating an exemplary process for displaying an activity mapping on a mobile device.

FIG. 2A is a top view of a mobile device displaying a coverage mapping in which the spatially-varying signal strengths of nearby base stations are provided in accordance with an embodiment of the present invention.

FIG. 2B is a flow chart illustrating an exemplary process for displaying a coverage mapping on a mobile device.

FIG. 3A is a top view of a mobile device displaying a location mapping in which an augmented reality image showing the locations of nearby base stations on an image captured by the camera on the mobile device.

FIG. 3B is a flow chart illustrating an exemplary process for displaying a location mapping on a mobile device.

FIG. 4A is a top view of a mobile device displaying installation information about a selected base station in accordance with an embodiment of the present invention.

FIG. 4B is a flow chart illustrating an exemplary process for displaying installation information about a selected base station.

FIG. 5 is a schematic block diagram illustrating a mobile device and a base station in accordance with an embodiment of the present invention.

### DETAILED DESCRIPTION OF THE INVENTION

It is an object of the present invention to provide a base station analysis system and method that may employ commercially-available mobile device platforms. The base station analysis application enables a service technician to locate nearby base stations in the field, determine which base stations are functioning properly, and retrieve information associated with the base stations. The mobile device displays nearby base stations on a street map relative to the location of the mobile device in an embodiment. The mobile device preferably displays the spatially-varying signal strength for the active base stations to enable the service technician to locate dead spots in the signal coverage. The mobile device also displays a reality augmented view having graphical icons which represent base stations embedded within a street-view image captured by the mobile device camera in a preferred embodiment. When a service technician selects a base station icon, installation information describing the base station is provided.

One or more embodiments of the present invention relates to mobile devices communicating to relatively small coverage area wireless base stations such as so-called PICO base stations related to the Long Term Evolution (“LTE”) technical standard. However, the description is not intended to limit the invention to the form disclosed herein, and is not intended to limit the invention to embodiments related to PICO base stations or the LTE technical standard.

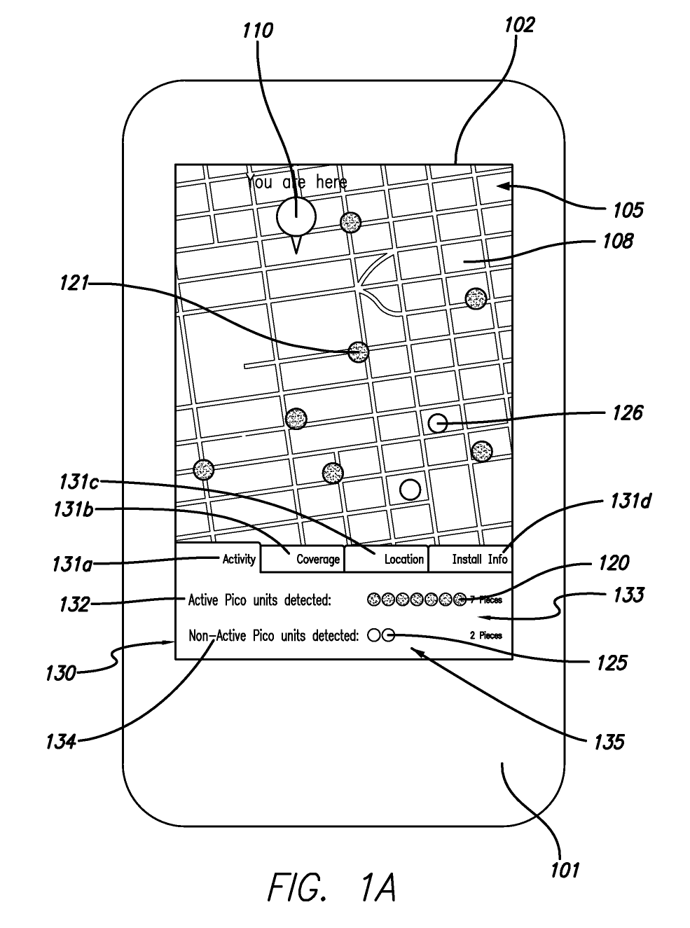

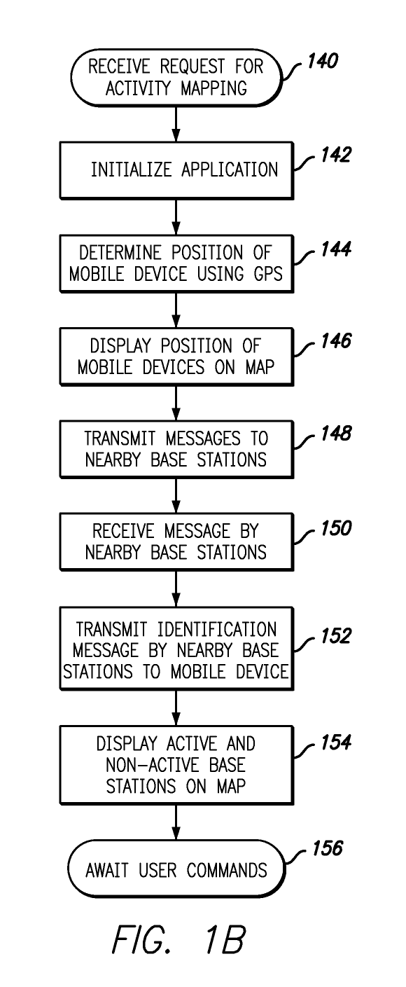

FIG. 1A is a top view of a mobile device 101 having a touch-screen display 102 in an embodiment. In the upper portion of the display 102, an activity mapping 105 is presented which shows a street map 108 of the region surrounding the mobile device 101. Icons associated with nearby base stations 121 and 126 relative to the location of the mobile device 101 are placed on the street map 108. Active and inactive base stations are distinguishable. For ease of illustration herein, icon 121 is shaded indicating that the mobile device 101 has determined that base station 126 is active. Icon 126 is not shaded which indicates that the mobile device 101 has determined that the base station 126 is not active. Alternatively, color, shape, or other features may be used, for example, the icons for the active base stations may be shown in one color, such as blue, and the icons for the non-active units may be shown in another color such as red, or can be identified by the icon shape, and located on the activity mapping. The icon 110 indicates the location of the mobile device 101 on the street map 108 and could be identified by the icon shape, and/or text as illustrated, or given a different color such as green, for example. Icons 121 and 126 have active links such that specific information of the associated base station can be retrieved.

In the lower portion of the display 102, a summary display 130 is presented which has an activity active tab 131a, a coverage active tab 131b, a location active tab 131c, and an install information tab 131d. When a user touches one of the active tabs 131a -131d, the mobile device 101 will provide the requested mapping and display screens 105, 205, 305, and 405 as depicted in FIGS. 1A, 2A, 3A, and 4A and discussed below. Note that each of the summary display screens 130, 230, 330, and 430 has active tabs to enable a user to readily retrieve the requested mapping.

The summary display 130 also has an active base stations label 132 and icons for active base stations 133, as well as a non-active base stations label 134 and icons for non-active units 135. The information presented in the summary display 130 would change dynamically depending on whether the area in activity mapping 105 is ‘zoomed-in’ or ‘zoomed-out.’

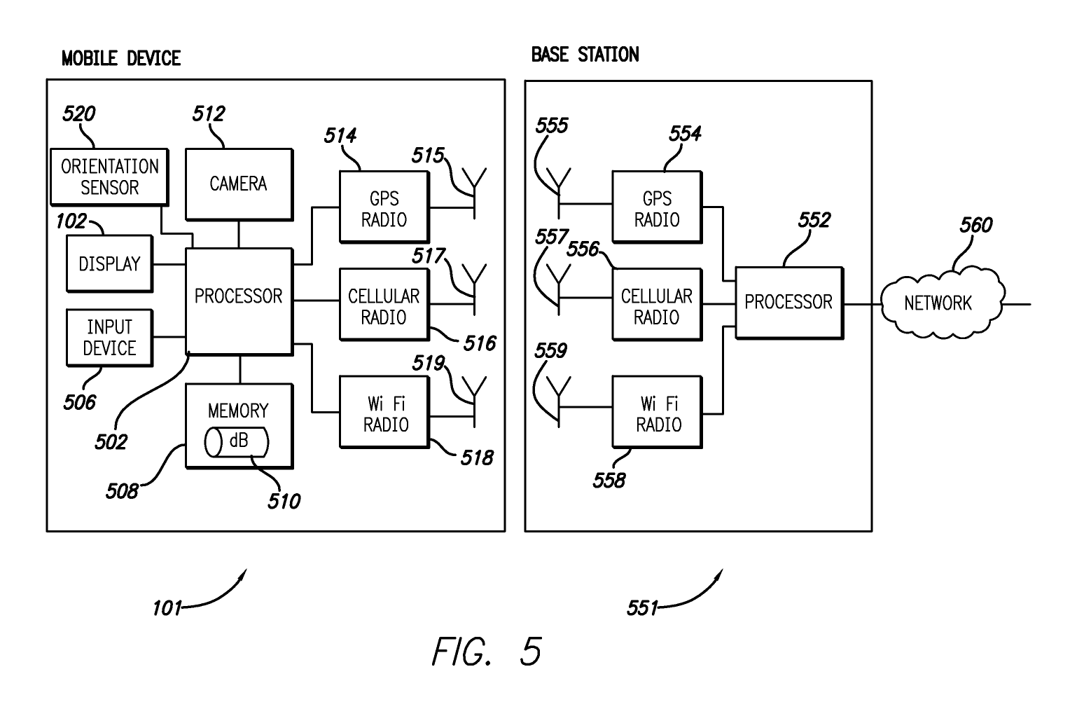

FIG. 5 is a schematic block diagram illustrating a mobile device 101 and a base station 551 in accordance with an embodiment of the present invention. Mobile device 101 has a processor 502 which controls the operation of the mobile device 101. Users interact with the mobile device through the display 102 and the input device 506. The input device 506 may be a touch screen or a keypad. The mobile device 101 has a GPS radio 514 coupled to antenna 515 for determining the location of the mobile device 101. The mobile device 101 has a cellular radio 516 and a corresponding antenna 517 as well as a Wi-Fi radio 518 and a corresponding antenna 519. The mobile device 101 has a camera 512 for obtaining images and an orientation sensor 520 for determining the orientation of the mobile device 101. The mobile device 101 has a memory 508 which may have a base station database 510 that holds information regarding base stations in a region.

The base station 551 has a processor 552 that controls the operation of the base station 551. The base station has a GPS radio 554 and a corresponding antenna 555 for determining the location of the base station 551. The base station 551 has a cellular radio 556 and a corresponding antenna 557 and a Wi-Fi radio 558 and a corresponding antenna 559. The processor 552 is coupled to a core IP network 560 through which the processor 552 receives commands from external sources.

FIG. 1B is a flow chart illustrating an exemplary process for displaying an activity mapping on the mobile device 101. The activity mapping feature is initiated when the mobile device 101 receives a request for activity mapping, such as by a user activating the activity tab 131a (step 140). The application initializes in the mobile device 101 (step 142). The initialization step 142 would only occur immediately after the mobile device 101 is initially powered and may not occur in an embodiment in which the mobile device is initially powered in one of the other modes. The mobile device 101 determines the position of the mobile device 101 by employing the GPS radio (step 144). The mobile device 101 may also determine its location by other means such as a user manually entering the location into the mobile device 101. The location of the mobile device is displayed on the activity mapping 105 as an icon 110 (step 146). The mobile device 101 then “pings” or transmits a message to the nearby base stations via the Wi-Fi radio 518 (step 148). Nearby base stations can be determined based on the location of the mobile device 101 and the locations of base stations stored in the base station database 510 in the mobile device 101. Alternatively, the location of base stations may be retrieved via the cellular radio 516 to a remote server hosting a base station database or the Wi-Fi radio 518 from a base station database. Active base stations 121 which are operational will receive the transmitted message (step 150). The active base stations 121 then transmit a responding identification message to the mobile device 101 (step 152). The mobile device then displays the icons 121 and 126 associated with the active and non-active base stations (step 154). The mobile device 101 then awaits further commands such as requests for other mappings (step 156).

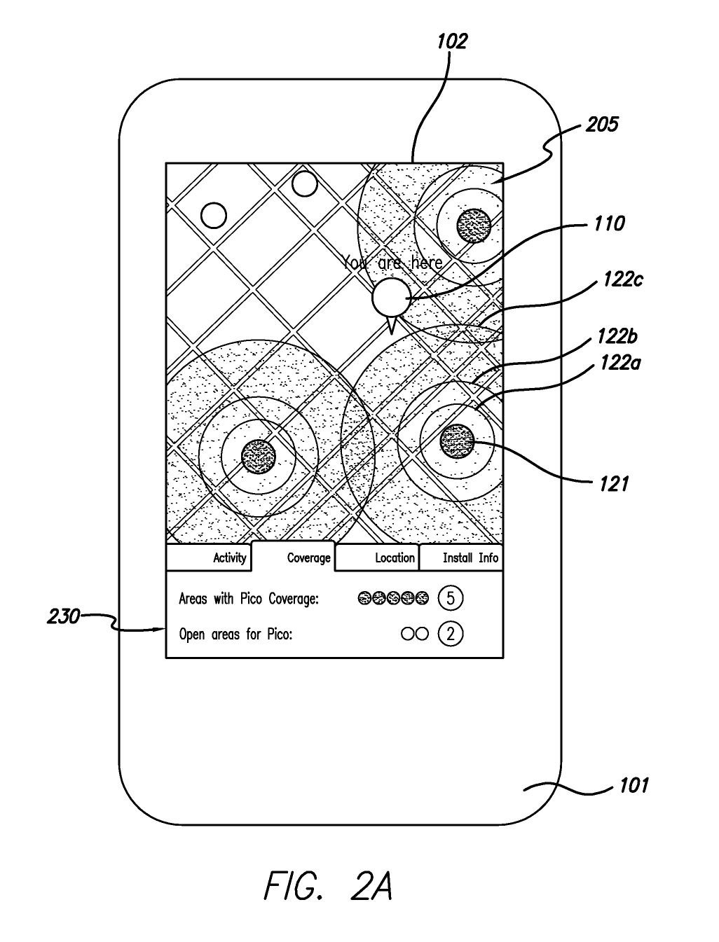

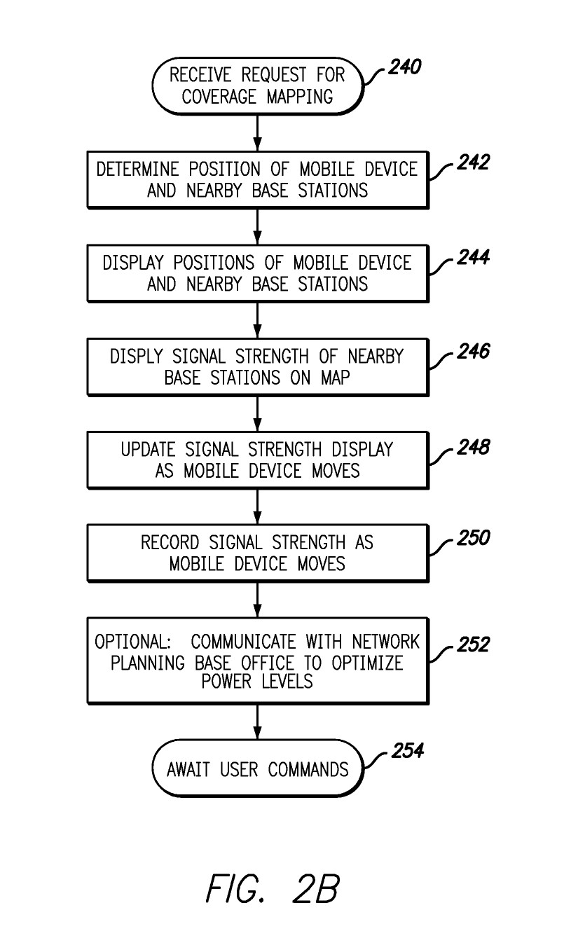

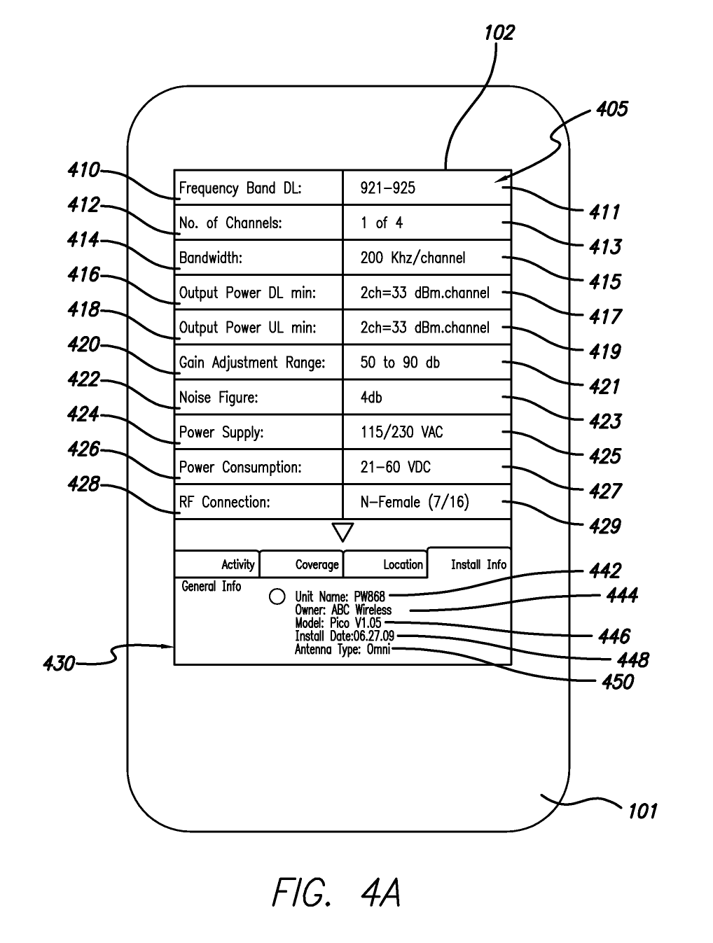

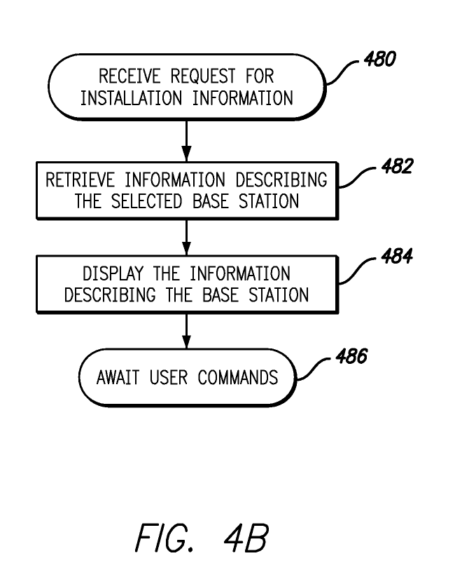

FIG. 2A is a top view of a mobile device displaying a coverage mapping 205 in the upper portion of display 102. The coverage mapping 205 displays the icon 110 representing the location of the mobile device 101, the active base stations, and an indication of the spatially-varying signal strength of the downlink signals from active base stations. For example, active base station 121 has a first coverage area 122a having the strongest signal strength, a second coverage area 122b having the next highest signal strength, and a third coverage area 122c indicating the effective coverage area of the base station 121. The various coverage areas may be graduated in color to define signal strength. The mobile device 101 displays the spatially-varying signal strength based on the theoretical or known coverage radius for the base station. The user can assess or be guided to determine the optimal location for the placement of the base stations. Icon 121 can be activated or “clicked” and unit specific information associated with the base station 121 can be retrieved as depicted in FIG. 4A and discussed below. The coverage mapping 205 could also be used to determine where additional base stations could be located to further enhance coverage. The mobile device 101 also has a summary display 230 which provides information for the area such as the areas with base station coverage and areas without base station coverage. The information provided in the summary display 230 would change dynamically depending on whether the area is ‘zoomed-in’ or ‘zoomed-out’.

FIG. 2B is a flow chart illustrating an exemplary process for displaying a coverage mapping 205 on a mobile device 101. The process begins when a user requests coverage mapping from one of the active icons (step 240). The mobile device 101 then determines the locations of the mobile device 101 and the nearby base stations (step 242). The mobile device 101 may determine its position by employing the GPS radio 514 in an embodiment. The locations of the nearby base stations may be determined based on the information contained in the base station data base 510. The coverage area for each of the active base stations 121 is determined and is displayed on the coverage mapping 205 (step 246). The coverage mapping 205 may have indicators that depict the spatially-varying signal strength of the active base stations within the range of the active base stations such as that depicted by coverage areas 122a, 122b, and 122c in FIG. 2A for example. The coverage areas 122a, 122b, and 122c may be based on the measured strength of signals received from the base station 121 that is converted to a coverage number, or may be based on a theoretical estimate of the signal strength. The coverage mapping 205 continually updates as the mobile device 101 is moved (step 248). The mobile device 101 records the signal strength as the mobile device moves, updates the mapping, and stores this signal strength along with the corresponding GPS location (step 250). The mobile device 101 may also transmit the information to a network planning location. Optionally, the mobile device 101 in addition may contact the network planning office and transmit instructions to increase or decrease power levels for the active base station 121 (step 252). The mobile device 101 then awaits further user commands (step 254).

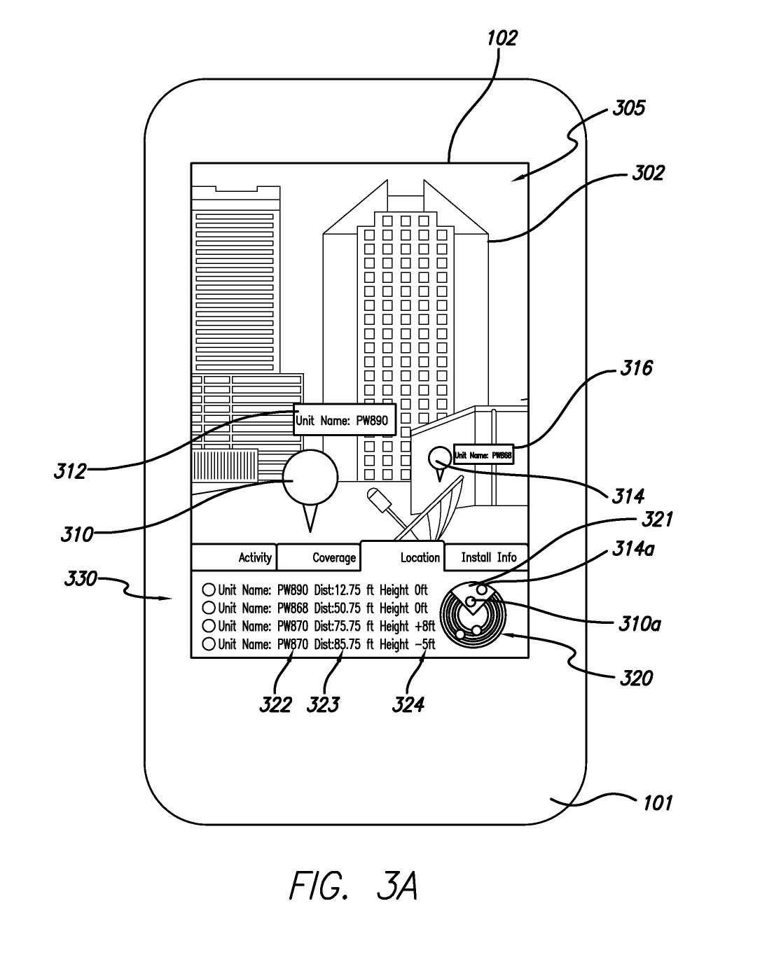

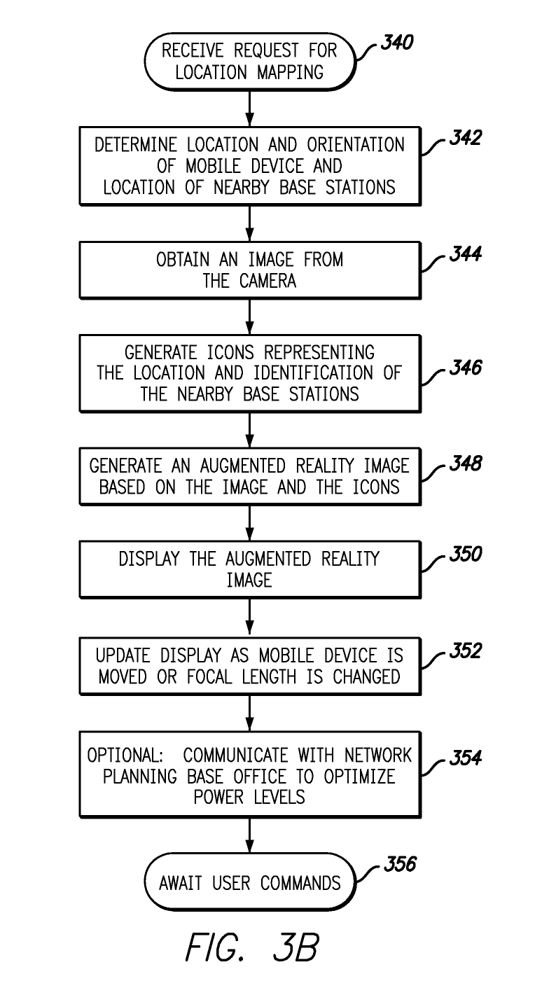

FIG. 3A is a top view of a mobile device 101 displaying a location mapping 305 in the upper portion of display 102. The location mapping 305 presents an augmented reality image showing icons at the locations of nearby base stations 310 and 314 on an image 302 captured by the camera 512. The mobile device 101 employs the GPS radio and mobile device camera 512 to generate the location mapping 305. Using the concept of augmented reality, the user is provided with an immediate 3D vicinity map of the icons depicting the base stations 310 and 314 against the image provided by the camera 512. Each icon 312 and 316 can be activated to reveal specific information of the base stations 310 and 314.

The lower portion of the display 102 has a summary display 330 that provides information for the area. The summary display 330 provides the summary of the nearby base station information including the base station identification 322 and its position relative to a coverage zone such as the relative distances 323 and relative heights 324. The summary display 330 would change dynamically depending on whether the area is ‘zoomed-in’ or ‘zoomed-out.’

The summary display 330 has graphical icon 320 which provides a top view of the immediate vicinity of the mobile device 101. The center of the graphical icon represents the location of the mobile device 101 and an upper section 321 representing the region that is being viewed by the camera 512. Within this upper section are base station icons 310a and 314a which correspond to the icons 310 and 314 in the in the region being viewed by the camera 512.

FIG. 3B is a flow chart illustrating an exemplary process for displaying a location mapping on a mobile device. The process begins when a user requests a location mapping (step 340). The location and orientation of the mobile device 101, and the location of the nearby base stations 310 and 314 are determined (step 342). The location of the mobile device 101 may be obtained from the GPS radio 514. The orientation of the mobile device 101 may be obtained from the orientation sensor 520. The location of the nearby base stations 310 and 314 may be obtained based on the location of the mobile device 101 and information contained in the base station database 510. An image 302 is obtained from the camera 512 (step 344). Icons are generated that represent the locations (310 and 314) and identifications of the nearby base stations 312 and 316 (step 346). An augmented reality image is generated based on the image from the camera 512 and generated icons (step 348). The augmented reality image is displayed (step 350). The location display 305 and the summary display 330 are updated as the mobile device 101 is moved or when the user changes the focal length or pointing direction of the camera 512 (step 352). Optionally, the mobile device 101 may in addition communicate with the network planning base office to optimize the power levels of the base stations 310 and 314 (step 354). The mobile device 101 then awaits further user commands (step 356).

FIG. 4A is a top view of a mobile device displaying installation information about a selected base station in accordance with an embodiment of the present invention. As described above, when the mobile device 101 is displaying the activity mapping, the coverage mapping, or the location mapping by selecting a base station icon, the user can access all the installation information available on that base station. The installation information can be scrolled up and down to access all the data. Among the labels and corresponding exemplary data which may be displayed includes downlink frequency band 410 and 411, the number of channels 412 and 413, the bandwidth of the base station 414 and 415, the minimum 416 and 417 and maximum 418 and 419 downlink output power levels, the gain adjustment range 420 and 421, the noise FIG. 422 and 423, the power supply 424 and 425, the power consumption 426 and 427, and the RD connector type 428 and 429. The summary display 430 provides the base station name 442, the owner of the base station 444, the model of the base station 446, the installation date of the base station 448, and the type antenna employed by the base station 450.

The installation information may also provide links to websites to allow access to sales/service, relevant building owner, network provider, replacement and stock availability, for example. The installation information may also display the owner of the base station, the unit model, the installation date, and the last service call, for example.

FIG. 4B is a flow chart illustrating an exemplary process for displaying installation information about a selected base station. The process begins when the user requests installation information (step 480). The mobile device 101 retrieves information describing the selected database (step 482). This information may be retrieved from a database 510 held within the mobile device 101 or through an external source that is accessed by the Wi-Fi radio 518 or the cellular radio 516. The mobile device 101 then displays the information describing the base station (step 484). The mobile device 101 then awaits further user commands (step 486).

The present invention has been described primarily as a system and method employing a base station analysis application that runs on commercially-available mobile device platforms. In this regard, the applications and mappings are presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A method for detecting and displaying information describing nearby base stations comprising:
determining a location of a mobile device;
determining locations of nearby base stations located near the mobile device;
generating a map graphic having a plurality of icons representing the location of the mobile device and the locations of the nearby base stations; and, displaying the map graphic.

2. The method for detecting and displaying information describing nearby base stations as set out in claim 1, wherein:
the mobile device comprises a GPS radio (Global Positioning System); and
determining the location of the mobile device comprises employing the GPS radio for determining the location of the mobile device.

3. The method for detecting and displaying information describing nearby base stations as set out in claim 2, wherein the mobile device further comprises a base station database, and wherein determining the location of nearby base stations further comprises determining the location of nearby base stations based on the base station database.

4. The method for detecting and displaying information describing nearby base stations as set out in claim 1, further comprising:
determining which of the nearby base stations are active base stations and which are non-active base stations;
wherein the plurality of icons representing the locations of the nearby base stations further comprise a plurality of icons representing the locations of the active base stations and the locations of the non-active base stations.

5. The method for detecting and displaying information describing nearby base stations as set out in claim 4, wherein determining which of the nearby base stations are active base stations and which of the nearby base stations are non-active base stations comprises:
transmitting a message from the mobile device;
receiving the message at the nearby base stations;
transmitting a response base identification message from the nearby base stations to the mobile device;
receiving the response base identification message; and,
classifying the nearby base stations as active base stations or non-active base stations based on the transmitted response base identification message.

6. The method for detecting and displaying information describing nearby base stations as set out in claim 1, further comprising:
determining the coverage areas for each of the active base stations; and,
displaying the coverage areas on the map graphic.

7. The method for detecting and displaying information describing nearby base stations as set out in claim 6, wherein the coverage areas further comprise indicators of the spatially-varying signal strength of each of the active base stations.

8. The method for detecting and displaying information describing nearby base stations as set out in claim 7, wherein the spatially-varying signal strength of each of the active base stations is based on the measured signal strength of signals transmitted by the active base stations.

9. The method for detecting and displaying information describing nearby base stations as set out in claim 7, wherein the spatially-varying signal strength of each of the active base stations is based on theoretical estimates of the signal strength.

10. The method for detecting and displaying information describing nearby base stations as set out in claim 7, further comprising recording signal strength information collected as the mobile device is moved.

11. The method for detecting and displaying information describing nearby base stations as set out in claim 6, further comprising:
contacting a network planning office;
transmitting instructions to increase or decrease the power level for one or more of the active base stations.

12. A method for detecting and displaying information describing nearby base stations comprising:
determining a position of a mobile device having a camera;
determining a location of a nearby base station located near the mobile device;
obtaining an image from the camera;
generating an icon representing the location of the nearby base station;
generating an augmented reality image based on the image and the icon; and,
displaying the augmented reality image.

13. The method for detecting and displaying information describing nearby base stations as set out in claim 12, further comprising:
determining a location of a second nearby base station located near the mobile device;
generating an icon identifying the second nearby base station; and,
displaying the icon identifying the nearby base station

14. The method for detecting and displaying information describing nearby base stations as set out in claim 12, further comprising:
generating a summary display listing the nearby base stations and the relative locations of the nearby base stations relative to the position of the camera.

15. The method for detecting and displaying information describing nearby base stations as set out in claim 12, wherein the mobile device further comprises a GPS (Global Positioning System), wherein determining the position of the mobile device comprises employing the GPS for determining the position of the mobile device.

16. The method for detecting and displaying information describing nearby base stations as set out in claim 12, further comprising:
contacting a network planning office; and,
transmitting instructions to increase or decrease the power level for one or more of the nearby base stations.

17. A method for detecting and displaying information describing nearby base stations comprising:
displaying a map indicating nearby base stations on a mobile device;
receiving a request for information describing a base station displayed on the mobile device by a user of the mobile device;
retrieving the information describing the base station; and,
displaying the information describing the base station on the mobile device.

18. The method for detecting and displaying information describing nearby base stations as set out in claim 17, wherein the mobile device further comprises a base station database, wherein retrieving the information describing the base station further comprises retrieving the information describing the base station from the base station database.

19. The method for detecting and displaying information describing nearby base stations as set out in claim 17, wherein the information describing the base station includes one or more of the downlink frequency band, the number of channels, the bandwidth of the base station, the minimum and maximum downlink output power levels, the gains adjustment range, the noise figure, the power supply, the power consumption, the RD connector type, the base station name, the owner of the base station, the model of the base station, the installation date of the base station, and the type of antenna employed by the base station.

20. The method for detecting and displaying information describing nearby base stations as set out in claim 17, further comprising providing active Internet website links for websites associated with the base station.
